(19) United States
(12) Patent Application Publication
(10) Pub. No.: US 2016/0076731 A1
(43) Pub. Date: Mar. 17, 2016

(54) Optical Arrangement and Display Device

(71) Applicant: OSRAM OPTO SEMICONDUCTORS GMBH, Regensburg (DE)

(72) Inventors: Wolfgang Mönch, Pentling (DE); Stefan Illek, Donaustauf (DE); Alexander Linkov, Regensburg (DE)

(21) Appl. No.: 14/784,779

(22) PCT Filed: Apr. 15, 2014
(86) PCT No.: PCT/EP2014/057644

§ 371 Date: Oct. 15, 2015

(30) Foreign Application Priority Data
Apr. 22, 2013 (DE) 10 2013 104 046.2

(51) Int. Cl. F21V 5/00; F21V 17/06; G02B 3/00

(52) U.S. Cl. CPC F21V 5/005; G02B 3/0056; F21V 5/004; F21V 17/06; F21Y 2105/001

(57) ABSTRACT

An optical arrangement includes a multiplicity of light-emitting chips on a carrier. In this case, first light-emitting chips respectively include pixels of a first group and second light-emitting chips respectively comprise pixels of a second group. Respectively one of the first and one of the second light-emitting chips are arranged in first unit cells in a planar fashion on the carrier. Furthermore, an optical element is provided, which is disposed downstream of the light-emitting chips in the emission direction. It is designed to guide light emitted by the pixels of the first and second groups in such a way that light from the pixels of the first group and light from the pixels of the second group are combined in second unit cells in a coupling-out plane, wherein the second unit cells each have an area that is smaller than the area of each of the first unit cells.

This patent application is a national phase filing under section 371 of PCT/EP2014/057644, filed Apr. 15, 2014, which claims the priority of German patent application 10 2013 104 046.2, filed Apr. 22, 2013, each of which is incorporated herein by reference in its entirety.

### TECHNICAL FIELD

The present invention relates to an optical arrangement and a display device.

### BACKGROUND

Modern display devices such as displays are often based on an arrangement of a multiplicity of picture elements or pixels. The resolution of such displays depends to a first approximation on the size of the picture elements themselves. Light-emitting chips on the basis of light-emitting diodes or LEDs can be used for producing high-resolution displays. A multiplicity of small light-emitting LED chips in the three primary colors such as red, green, blue (RGB) have to be assembled for displaying colors. Approximately 6 million chips are required in the case of HDTV (high-definition television). This approach has various disadvantages. Firstly, placing and contacting a multiplicity of small chips require a not insubstantial amount of time and technical outlay. Furthermore, the efficiency and area use of small chips are reduced by area losses during the production process, for example, by separation and contacting. Finally, small chips are more susceptible to small current problems than larger chips.

Alternatively, use can be made of pixilated LED chips having one primary color, usually blue, and the pixels thereof can alternately be provided with suitable conversion elements for other colors such as green and red. In addition to the lack of highly efficient and stable red converters, it is the necessary thickness of the conversion elements of approximately 100 μm in particular that constitutes a geometric limitation of the realizable minimal pixel dimensions.

### SUMMARY

Embodiments of the present invention provide an optical arrangement and a display device that is producible by way of a simpler process and that can provide a high resolution.

In one embodiment, an optical arrangement comprises a multiplicity of light-emitting chips on a carrier. The optical arrangement comprises first light-emitting chips which each have a plurality of pixels of a first group. Furthermore, the arrangement comprises second light-emitting chips, which each have a plurality of pixels of a second group. Furthermore, in each case one of the first light-emitting chips and one of the second light-emitting chips are arranged in a first unit cell in an areal manner on the carrier. The optical arrangement moreover comprises an optical element, which is disposed downstream of the light-emitting chips in the emission direction.

The optical element is configured to combine light emitted by the pixels of the first and second group in second unit cells in a decoupling plane in such a way that at least one second unit cell has an area that is smaller than the area of respectively one of the first unit cells. It is furthermore possible for each second unit cell to have an area that is smaller than the area of respectively one of the first unit cells. By way of example, the optical arrangement comprises a first unit cell and at least two second unit cells, wherein the second unit cells each have an area that is smaller than the area of the first unit cell.

By way of example, the carrier is manufactured from ceramic material and comprises electrical connections in order to be able to connect the optical arrangement to a controller. Here, preferably, the pixels of the first group are configured to emit light with a first wavelength while the pixels of the second group are configured to emit light with a different wavelength. By way of example, the pixels of the first group emit red light while the pixels of the second group emit green light, or vice versa. However, it is also possible for the pixels of the first group or the pixels of the second group to emit blue light. The individual pixels, which are also referred to as picture elements, are preferably implemented using light-emitting diodes. The optical element preferably comprises optical components such as lenses, in particular Fresnel lenses, gratings or binary diffractive elements.

The term “unit cell” relates to the arrangement of the light-emitting chips or to the luminous areas, ordered to form groups, of the individual light-emitting chips. One or more light-emitting chips with pixels of the first group and one or more light-emitting chips with pixels of the second group are respectively arranged within the first unit cells, wherein, preferably, the number and/or arrangement of the respective chips are the same in the first unit cell. Pixels of one group are preferably adjacent to one another. Furthermore, they are preferably similar to one another within the meaning of pixels of one group having the same peak or dominant wavelength or emitting in the same spectral range or being of the same manufactured type. Production-dependent deviations, such as different emission intensities, may occur. A light-emitting chip with a group of pixels is adjacent to a further light-emitting chip with a further, preferably different, group of pixels. In particular, the smallest unit of adjacent light-emitting chips that can be used to describe the optical element forms a first unit cell within the meaning of this application. Furthermore, the phrase “areal arrangement on the carrier” should be understood to mean that the light-emitting chips can be arranged both next to one another, for example, in one row, and also in the style of a matrix.

The second unit cells are defined in the decoupling plane. They comprise the light, guided by the optical element, from the pixels of different groups. In particular, a second unit cell is the smallest unit of adjacent pixels in the decoupling plane that can be used to describe the light redistribution in the decoupling plane.

A simplified production method is possible by using light-emitting chips with in each case groups of similar light-emitting picture elements or pixels. Similar groups of pixels are combined in the respective light-emitting chip. This is advantageous for the production because it is possible to dispense with a filter arrangement with different color filters, for example, in the style of a Bayer matrix, or with converters assigned to the individual pixels. This makes the production method not only simpler but also more cost-effective.

A high resolution of the whole optical arrangement is obtained by using the optical element since light from pixels of different groups is combined in each case in the second unit cells, even though the light-emitting chips with groups of similar pixels are respectively adjacent to one another in the first unit cells. In particular, the resolution is not restricted by the size of the light-emitting chips, for example, by the edge length thereof. Rather, the achievable resolution depends on the size of the pixels themselves, the emitted light of which is redistributed by the optical element.

The redistribution leads to light with different wavelengths being combined in the second unit cells and these unit cells having a smaller area than the first unit cells which are substantially formed by the light-emitting chips with groups of similar pixels. Thus, the optical arrangement redistributes the light emitted by the chips in such a way that the resulting second unit cells (consisting of pixels) are smaller than the first unit cells (consisting of chips). In other words, the optical arrangement can deflect and moreover focus the light emitted by the chips. By way of example, the second unit cells of the pixels have an edge length that is smaller than that of the first unit cells by a factor of 4. As a result, advantages emerge for the design of directly emitting RGB displays.

According to a further embodiment, third light-emitting chips are arranged in an areal manner on the carrier and respectively have a plurality of pixels of a third group. The first unit cell now comprises respectively one of the first, the second and the third light-emitting chips.

The pixels of the third group can emit light with a wavelength that respectively differs from the wavelength of the light emitted by the pixels of the first group and of the light emitted by the pixels of the second group. In particular, the pixels of the first, the second and the third group can emit light that in each case has a different spectral color than the light of the pixels of the other two groups. By way of example, pixels of one group therefore produce red light, pixels of a further group produce green light and pixels of the last group produce blue light. The first, the second and the third light-emitting chips therefore produce light with three different colors.

Here, the optical element is configured to combine light emitted by the pixels of the first, second and third group in such a way in second unit cells in the decoupling plane that at least one second unit cell has an area that is smaller than the area of respectively one of the first unit cells.

By using third light-emitting chips with a third group of pixels it is possible to display more colors using the optical arrangement. By way of example, this provides a basic configuration for displaying a specific color model. By way of example, the pixels of the first, second and third group can be assigned to the primary colors red, green and blue of the RGB color model. The optical element is then able to provide second unit cells which have three primary colors and therefore, for example, have all RGB primary colors.

According to a further embodiment, a first light-emitting chip, a second light-emitting chip and a third light-emitting chip are in each case arranged laterally or in a matrix arrangement next to one another on the carrier.

According to a further embodiment, at least fourth light-emitting chips are arranged on the carrier in an areal manner and each have a plurality of pixels of at least one fourth group. In this case, the first unit cell comprises respectively one of the first light-emitting chips, the second light-emitting chips, the third light-emitting chips and at least one fourth light-emitting chip. By way of example, the pixels of the fourth group can emit green light.

Here, the optical element is configured to combine light emitted by the pixels of the first, second, third and at least fourth group in second unit cells in the decoupling plane in such a way that at least one second unit cell has an area that is smaller than the area of respectively one of the first unit cells.

The use of at least fourth light-emitting chips constitutes a development of the previously presented arrangement on the basis of two or three different light-emitting chips. Here, what is possible is that a fourth color is respectively assigned to the pixels of the fourth group such that the optical arrangement can display a color model on the basis of four primary colors. However, it is also possible that two of the total of four light-emitting chips or their respective groups of pixels emit the same wavelength and thus, for example, are able to represent a Bayer matrix with the colors red, two times green and blue. Other assignments are likewise possible, just like fifth light-emitting chips with in each case a plurality of pixels of a fifth group, etc.

According to a further embodiment, at least one of the first unit cells has a multiplicity of first or second light-emitting chips.

According to a further embodiment, the carrier has a flat or curved surface. In this manner, the optical arrangement can be used in a plane, for example, as a luminous surface or display. However, it is likewise possible for the arrangement to be embodied in accordance with a three-dimensional form by means of a curved carrier.

In accordance with a further embodiment, the first, second, third and/or fourth light-emitting chips are arranged in a regular two-dimensional lattice on the carrier. In particular, the regular two-dimensional lattice can be periodic or quasi-periodic.

By way of example, the lattice emerges from periodic or quasi-periodic repetition of the arrangement of light-emitting chips, defined in the first unit cells, on the carrier. Preferably, the repetition is defined by translation in two different directions along the face of the carrier. What also emerges thus as a result of the embodiment of the optical element is a repeating lattice in the decoupling plane on the basis of the second unit cells.

According to a further embodiment, the regular two-dimensional lattice has a quadratic, a hexagonal or a quasi-crystalline lattice.

Here, it is possible to arrange the light-emitting chips in accordance with the two-dimensional lattice in the form of squares, hexagonal or quasi-crystalline lattices. By way of example, if the target application is a curved, areal direct display, correspondingly curved chip arrangements can be considered, just like a two-dimensional lattice in the style of pentagons and hexagons is suitable, for example, for building up a sphere-shaped football.

Furthermore, it is conceivable that the respective groups of pixels of the light-emitting chips are arranged in the form of a quadratic, a hexagonal or a quasi-crystalline pattern. The respective two-dimensional lattices can then be realized in such a way that the respective light-emitting chips are arranged adjacent to one another at the outer edges thereof or directly adjoining one another, and hence form the two-dimensional lattice in the form of a square, a hexagon or, in general, a polygonal form.

A regular lattice can be constructed by periodic repetition of the unit cell in the three spatial directions and therefore only has 2-fold, 3-fold, 4-fold and 6-fold symmetries. However, a double unit cell (or unit cell of higher order) can also be repeated in a non-periodic manner and denotes a quasi-crystalline lattice within the meaning of this application. An example is, for example, a so-called Penrose lattice.

In a further embodiment, further light-emitting chips are arranged in an areal, in particular plane, manner on the carrier and respectively comprise a further group of pixels. The first unit cells then respectively comprise one of the first, the second, the third, the fourth and the further light-emitting chips, for example, fifth light-emitting chips with in each case a plurality of pixels of a fifth group.

Then, the optical element is configured to combine light emitted by the pixels of the first, second, third, fourth and the further group in such a way in second unit cells in the decoupling plane that at least one second unit cell has an area that is smaller than the area of respectively one of the first unit cells. Furthermore, each second unit cell can have an area that is less than the area of respectively one of the first unit cells.

The use of further light-emitting chips and further groups of pixels thus, as it were, constitutes a generalization of the principle of the optical arrangement present. Using this, it is possible in a flexible manner to combine light-emitting chips with different light-emitting pixels to form a relatively large arrangement.

According to a further embodiment, the hybrid made of carrier, light-emitting chips and optical element is integrated. In this case, a component with component parts that are already aligned in relation to one another during the production and are consequently secured against adjustment emerges within the scope of producing the optical arrangement. Alternatively, it is possible for the carrier to be equipped with the light-emitting chips and the optical element. In this case, the optical arrangement is modular and the individual components can be produced separately from one another. Thus, it is possible, for example, to produce the optical arrangement on the basis of a wafer. Preferably, a light-emitting wafer and a micro-optics wafer, which comprises the optical element, are produced separately and then connected.

According to a further embodiment, the optical element comprises an arrangement of micro-lenses. Here, the micro-lenses are configured to collimate divergent radiation beams of the light emitted by the light-emitting chips. Moreover, it is possible to merge parallel radiation beams. Thus, beam guidance is realized with the aid of the micro-lenses such that light from the respective pixels of the light-emitting chips is guided into the second unit cells.

According to a further exemplary embodiment, the optical element comprises a prism arrangement. Here, the prism arrangement is configured to guide and/or deflect light.

With the aid of the prism arrangement there is a redistribution of the light from the respective groups of pixels in the different light-emitting chips from the first unit cells to the second unit cells. The prism arrangement can be embodied in such a way that the angle of inclination and the alignment of the individual prisms are different in each case for different pixels.

In a further embodiment, the micro-lens arrangement and the prism arrangement are integrated monolithically in the optical element.

According to a further embodiment, the micro-lens arrangement and the prism arrangement are embodied as separate elements.

According to a further embodiment, the pixels arranged on the carrier can each be actuated separately. In particular, the intensity of the light emitted in each case by an actuated pixel is adjustable.

In this manner, it is possible to realize, e.g., a display such as an LED direct display, i.e., a display without an LCD imager. Otherwise, an imaging element, e.g., an LCD, must be disposed downstream for displays with LEDs having homogeneously luminous pixels. Inter alia, an advantage thereof is a comparatively higher resolution.

According to a further embodiment, the pixels arranged on the carrier are configured to emit light in accordance with a color model standard. In particular, the color model standard can comprise an RGB or RGBY color model.

According to one embodiment, a display device comprises an optical arrangement as shown above. Moreover, the display device comprises a controller for actuating the pixels arranged on the carrier.

The multiplicity of light-emitting chips can be arranged on a carrier with suitable dimensions. Here, the first unit cell constitutes the smallest unit. In this manner, the optical arrangement can be combined to form, and operated as, a display device such as a screen, television or monitor. In the case of a given resolution, e.g., for an HDTV (high definition television) display, a display device of the proposed type, which has pixelated chips and the above-described optical element, requires significantly fewer chips than a comparable display device made of small individual chips.

### BRIEF DESCRIPTION OF THE DRAWINGS

Below, the invention will be explained in more detail using a plurality of exemplary embodiments on the basis of figures. To the extent that parts or components have a corresponding function, the description thereof will not be repeated in each one of the following figures.

In detail:

FIGS. 1A, 1B, 1C show exemplary embodiments of an optical arrangement; and

FIG. 2 shows a further exemplary embodiment of an optical arrangement.

### DETAILED DESCRIPTION OF ILLUSTRATIVE EMBODIMENTS

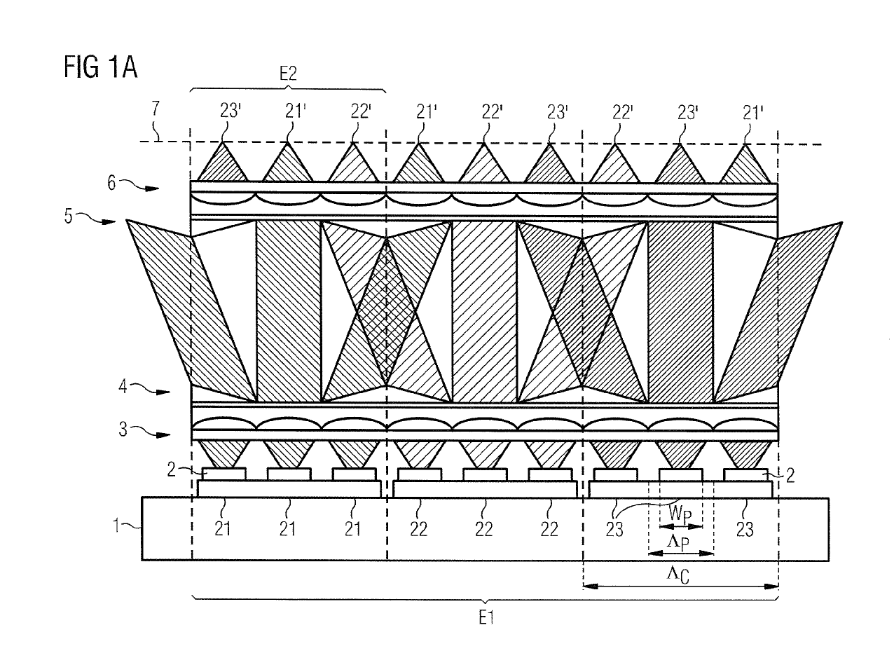

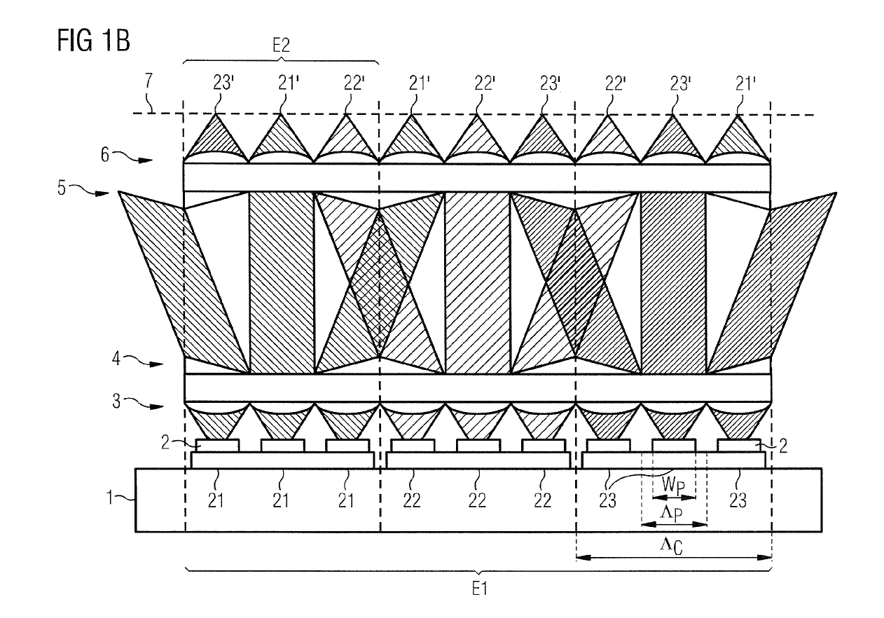

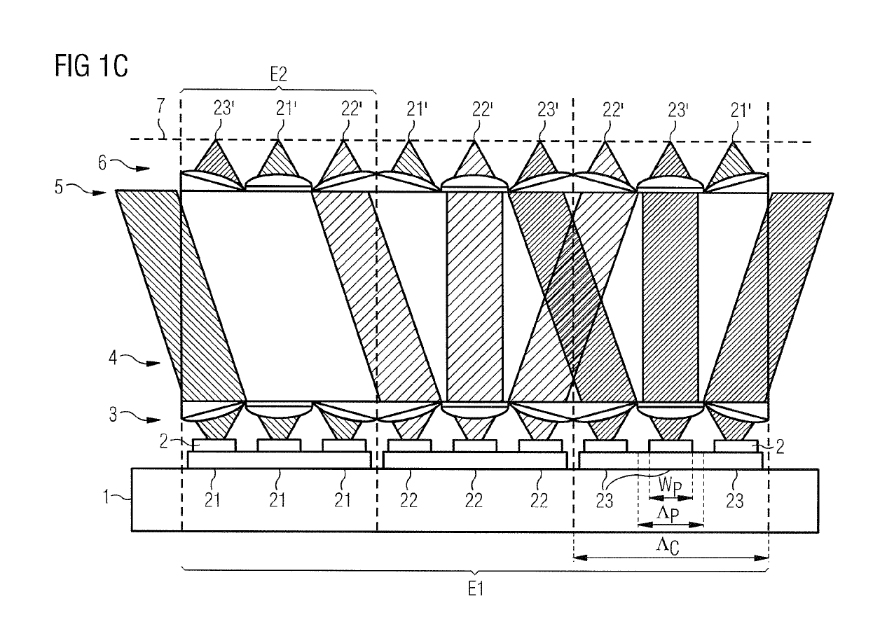

FIG. 1A shows an exemplary embodiment of an optical arrangement. A plurality of light-emitting chips 2 are arranged on a system carrier 1, which can, for example, be constructed from a ceramic. The light-emitting chips 2 in each case comprise a group of light-emitting pixels 21, 22, 23, which are each configured to emit different colors. Thus, for example, a light-emitting chip 2 in FIG. 1A comprises pixels of a first group 21. A further light-emitting chip 2 has pixels of a second group 22 and a third light-emitting chip 2 comprises corresponding pixels of a third group 23. By way of example, the different pixels of the groups 21, 22, 23 can emit the colors red, green and blue. In this exemplary embodiment, the three light-emitting chips with the first, second and third groups 21, 22, 23 are arranged laterally next to one another and thus form a first unit cell E1.

The system carrier 1 and the pixelated light-emitting chips 2 can be a monolithic component. Alternatively, the system carrier can be manufactured separately and subsequently be equipped with the individual chips. Electrical wiring and details of the design and the corresponding components such as, e.g., adhesives, solder, solder pads, bond wires and the like are not shown in the drawing. The pixels of the individual chips typically have a diameter Wₚ in the region of 50 μm and are arranged in a pixel grid of 20 to 30 μm in relation to one another. The chips have an edge length Λ_{c} of the order of 1000 μm.

Disposed downstream of the light-emitting chips in the emission direction is an array of micro-lenses 3, followed by a prism array 4, a further prism array 5 and a further micro-lens array 6. These optical components form an optical element for collimating and guiding the light emitted by the pixels of the different groups. Alternatively, or in a complementary manner, use can also be made of gratings, holographic elements, Fresnel lenses and binary diffractive elements instead of the micro-lenses and/or prisms. Furthermore, a decoupling plane 7 (which is also denoted an evaluation plane) is shown and it, as will be shown below, corresponds to a new light source with emission surfaces redistributed in a pixel-by-pixel manner.

Further details of the optical element are not shown in FIG. 1A. By way of example, these comprise stops for optical channel separation, further stops, e.g., in the evaluation plane 7, mechanical and adjustment components such as spacers, adjustment marks and the like.

During operation of the optical arrangement, which is shown in section with three pixelated light-emitting chips with the groups 21, 22 and 23 in this FIG. 1A, the pixels of the first group 21, the pixels of the second group 22 and the pixels of the third group 23 each emit in accordance with the emission spectrum thereof. By way of example, in this exemplary embodiment, the pixels of the first group 21 emit a red light, the pixels of the second group 22 emit a green light and the pixels of the third group 23 emit a blue light. The individual pixels can be provided with additional optics, for example, a lens, but will in general emit in a divergent manner.

On the micro-lens array 3 the individual beams in each case impact on corresponding micro-lenses 3 disposed downstream of the individual pixels. These micro-lenses 3 collimate the light of the individual pixels, which light was emitted in a divergent manner in each case by said pixels. The individual light beams now fall in a collimated, preferably parallel, manner on the prism array 4 arranged downstream, with this element deflecting the collimated light by a predetermined angle. The respective angle can be different from pixel to pixel. However, the angles are selected in such a way that, subsequently, the respective deflected light beams are deflected to the second prism array 5 and, there, are deflected parallel back to a normal of the array 5. Additionally, the second micro-lens array 6 is situated in such a position that the light beams previously deflected by the first and second prism arrays 4, 5 can be registered and focused on the decoupling plane 7 which is disposed downstream. To this end, the position of individual lenses in the second micro-lens array 6 is likewise adapted to the deflection angles of the light beams previously deflected by the prism arrays 4, 5.

Therefore, there is a redistribution of the light beams, emitted by the pixels of the light-emitting chips, in the decoupling plane 7 by way of the micro-lens arrays 3, 6 and the prism arrays 4, 5 such that, as indicated by dashed lines in the drawing, three colors are respectively adjacent to one another in a second unit cell E2 as redistributed pixels 21′, 22′ and 23′. In other words, the redistribution caused by the optical element allows an increase in the resolution of the optical arrangement to be obtained.

In FIGS. 1A, 1B, and 1C, the optical arrangement is merely shown in a section comprising three different light-emitting chips. Corresponding further light-emitting chips in accordance with the principles explained above may be found adjoining the respective left-hand or right-hand side of the shown section. Furthermore, it is possible for the linear arrangement shown here to be complemented by further arrangement in a second dimension and hence that this results in an areal two-dimensional optical element.

FIG. 1B shows a further exemplary embodiment of an optical arrangement. The optical arrangement shown here is based on the arrangement shown in FIG. 1A, whereas merely the first micro-lens array 3 and the second prism array 4 or the second prism array 5 and the second micro-lens array 6 are respectively embodied integrally, for example, as monolithic components.

FIG. 1C shows a further exemplary embodiment of an optical arrangement according to the proposed principle. This arrangement is also based on the arrangement shown in FIG. 1A. The components forming the optical element, i.e., the first and second micro-lens array 3, 6 and the first and second prism array 4, 5, are comprised together by a monolithic component here.

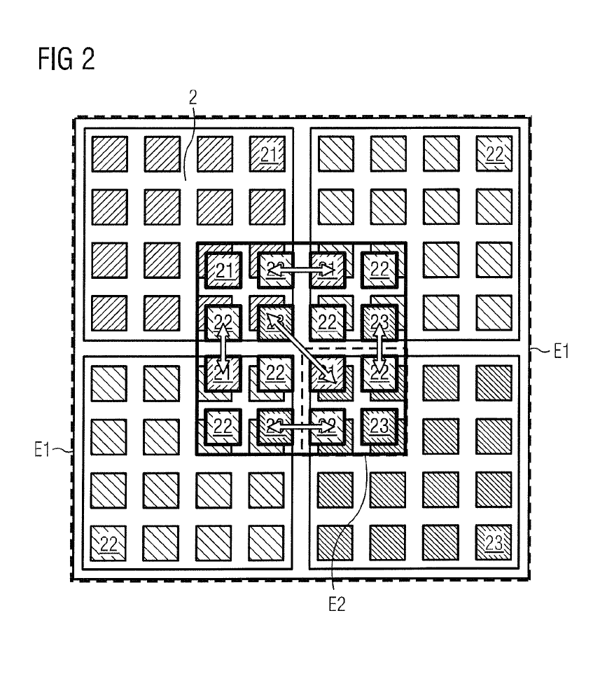

FIG. 2 shows a further exemplary embodiment of an optical arrangement. The arrangement shown here constitutes a two-dimensional areal arrangement with a first square unit cell E1 made of four light-emitting chips, which form a square pattern. Here, two similar light-emitting chips are provided. In the arrangement, at least one light-emitting chip is provided for each first, second and third group of light-emitting pixels 21, 22, 23. The pixels of the first group 21 emit, e.g., red light, the pixels of the second group 22 emit, e.g., green light and the pixels of the third group 23 emit, e.g., blue light.

In a similar manner, as shown schematically in FIGS. 1A to 1C, corresponding optical elements are situated downstream, above the light-emitting chips, which optical elements respectively comprise the first and second micro-lens array and the first and second prism array. Here, the optical elements are set in such a way that the light emitted by the pixels is emitted from the first unit cell E1 into a second unit cell E2 in such a way that adjacent pixels in each case contain different colors and such that, hence, a higher resolution is obtained. The redistribution as a result of the optical element is indicated by the white arrows in the figure.

The embodiment of the micro-lens arrays 3, 6 and of the prism arrays 4, 5 is similar to the embodiments in accordance with FIGS. 1A to 1C. The latter collimate and guide the light, emitted by the individual pixels, along one direction. In principle, it is possible, for a two-dimensional arrangement, for this principle to be applied to the lines or columns thereof. However, it may be advantageous if the micro-lens arrays 3, 6 and the prism arrays 4, 5 are configured in such a way that light is also redistributed between the lines and columns of the light-emitting chips. This is advantageous, inter alia, in that light from one pixel only needs to be deflected slightly.

The diameter of the micro-lenses is preferably no less than 50 μm so that the optical properties thereof are substantially refractive. It is advantageous for the angle deflection by the prism arrays to be small, for example, less than 30°, preferably less than 15°, particularly preferably less than 10°. This is the case if the light emitted by a pixel on the chip is only deflected to an adjacent pixel in the decoupling plane 7 in a top view.

The shown optical arrangement redistributes the light emitted by the light-emitting chips, e.g., LED chips, in such a way that the resultant second unit cells E2, which have the pixel groups 21, 22, 23, are smaller than the first unit cells E1, which are defined by the chip arrangement itself. In FIG. 2, the second unit cells E2 of the pixel have an edge length that is smaller by a factor of 4 than that of the first unit cells E1 of the chips. As a result, advantages emerge for the design of directly emitting RGB displays. By way of example, realistic numerical values are 500 μm for the edge length Λ_{c} of the chips and 100 μm for the edge length or grid dimension Λₚ of the pixels. Thus, for example, the following relationships emerge:

Lattice constant chip/lattice constant pixel=(Λ_{c}/Λₚ)=5

Area chip/area pixel=(Λ_{c}/Λₚ)²=25.

In the case of a given resolution (e.g., for HDTV), a direct LED display made of pixelated chips and with the described optical arrangement requires 25 times fewer chips than a direct LED display made of small individual chips.

The invention is not restricted by the description on the basis of the exemplary embodiments. Rather, the invention comprises each new feature and each combination of features; this, in particular, includes every combination of features in the patent claims, even if this feature or this combination itself is not explicitly specified in the patent claims or in the exemplary embodiments.

1-17. (canceled)

18. An optical arrangement comprising:
a plurality of light-emitting chips on a carrier, wherein first light-emitting chips each have a plurality of pixels of a first group, second light-emitting chips each have a plurality of pixels of a second group, and in each case one of the first light-emitting chips and one of the second light-emitting chips are arranged in first unit cells in an areal manner on the carrier; and
an optical element disposed downstream of the light-emitting chips in an emission direction and configured to combine light emitted by the pixels of the first and second group in second unit cells in a decoupling plane in such a way that a second unit cell has an area that is smaller than an area of a first unit cell.

19. The optical arrangement according to claim 18, further comprising third light-emitting chips arranged in an areal manner on the carrier, each third light-emitting chip having a third group of pixels;
wherein the first unit cells respectively comprise one of the first, the second and the third light-emitting chips; and
wherein the optical element is configured to combine light emitted by the pixels of the first, second and third groups in such a way in second unit cells in the decoupling plane that a second unit cell has an area that is smaller than the area of a first unit cell.

20. The optical arrangement according to claim 19, wherein the first, the second and the third light-emitting chips emit light with pairwise different colors.

21. The optical arrangement according to claim 19, wherein in each case a first light-emitting chip, a second light-emitting chip and a third light-emitting chip are arranged laterally next to one another or in a matrix arrangement on the carrier.

22. The optical arrangement according to claim 19, further comprising fourth light-emitting chips arranged on the carrier in an areal manner, each fourth light-emitting chip having a fourth group of pixels;
wherein the first unit cells respectively comprise one of the first, the second, the third and the fourth light-emitting chips; and
wherein the optical element is configured to combine light emitted by the pixels of the first, second, third and the fourth groups in second unit cells in the decoupling plane in such a way that a second unit cell has an area that is smaller than the area of the first unit cell.

23. The optical arrangement according to claim 22, wherein the first, second, third or fourth light-emitting chips are arranged in a regular two-dimensional lattice on the carrier.

24. The optical arrangement according to claim 23, wherein the regular two-dimensional lattice has a quadratic pattern, a hexagonal pattern or a quasi-crystalline pattern.

25. The optical arrangement according to claim 18, wherein each one of the second unit cells has an area that is smaller than the area of each one of the first unit cells.

26. The optical arrangement according to claim 18, wherein at least one of the first unit cells has a plurality of first and second light-emitting chips.

27. The optical arrangement according to claim 18, wherein the carrier has a flat or curved surface.

28. The optical arrangement according to claim 18, wherein:
a hybrid comprising the carrier, the light-emitting chips and the optical element is integrated; or
the carrier is equipped with the light-emitting chips and the optical element.

29. The optical arrangement according to claim 18, wherein the optical element has an arrangement of micro-lenses configured to parallelize divergent radiation beams of the light emitted by the light-emitting chips and/or combine parallel radiation beams.

30. The optical arrangement according to claim 29, wherein the optical element has a prism arrangement configured to guide or direct light; and
wherein the micro-lens arrangement and the prism arrangement are integrated in the optical element in monolithic fashion or are embodied as separate elements.

31. The optical arrangement according to claim 18, wherein the optical element has a prism arrangement configured to guide or direct light.

32. The optical arrangement according to claim 18, wherein the pixels of at least one light-emitting chip are separately actuatable, such that the intensity of the light respectively emitted by the pixels is adjustable.

33. The optical arrangement according to claim 18, wherein the pixels are configured to emit light in accordance with a color model standard.

34. A display device comprising:
an optical arrangement according to claim 18; and
a controller for actuating the pixels.

35. An optical arrangement comprising:
a plurality of light-emitting chips on a carrier, wherein first light-emitting chips each have a plurality of pixels of a first group, second light-emitting chips each have a plurality of pixels of a second group, and in each case one of the first light-emitting chips and one of the second light-emitting chips are arranged in first unit cells in an areal manner on the carrier; and
an optical element disposed downstream of the light-emitting chips in an emission direction and configured to combine light emitted by the pixels of the first and second group in second unit cells in a decoupling plane in such a way that a second unit cell has an area that is smaller than the area of a first unit cell;
wherein the pixels of the first group are configured to emit light with a first wavelength;
wherein the pixels of the second group are configured to emit light with a second wavelength that differs from the first wavelength; and
wherein pixels of one group have the same peak or dominant wavelength or emit light in the same spectral range.

36. The optical arrangement according to claim 35, further comprising third light-emitting chips arranged in an areal manner on the carrier, each third light-emitting chip having a third group of pixels;
wherein the first unit cells each comprise one of the first, the second and the third light-emitting chips;
wherein the optical element is configured to combine light emitted by the pixels of the first, second and third groups in such a way in second unit cells in the decoupling plane that a second unit cell has an area that is smaller than the area of a first unit cell; and
wherein the first, the second and the third light-emitting chips emit light with pairwise different colors.

37. The optical arrangement according to claim 35, further comprising an arrangement of micro-lenses configured to parallelize divergent radiation beams of the light emitted by the light-emitting chips or combine parallel radiation beams.
